(19) United States
(12) Patent Application Publication
(10) Pub. No.: US 2025/0081238 A1
(43) Pub. Date: Mar. 6, 2025

(54) MANAGING COEXISTENCE OF COMMUNICATION PROTOCOLS IN USER DEVICE

(71) Applicant: Apple Inc., Cupertino, CA (US)

(72) Inventors: Yaranama Venkata Ramana Dass, Belmont, CA (US); Arun Vijayakumari Mahasenan, Fremont, CA (US); Camille Chen, Cupertino, CA (US); David D Cheng, Los Altos, CA (US); Hsin-Yao Chen, Castro Valley, CA (US); Langford M. Wasada, Poway, CA (US); Sarvesh Kumar Varatharajan, Sunnyvale, CA (US); Venkateswara Rao Manepalli, San Jose, CA (US)

(21) Appl. No.: 18/805,449

(22) Filed: Aug. 14, 2024

Related U.S. Application Data
(60) Provisional application No. 63/536,031, filed on Aug. 31, 2023.

(51) Int. Cl. H04W 74/0816; H04W 60/04; H04W 74/08; H04W 76/10

(52) U.S. Cl. CPC H04W 74/0816; H04W 60/04; H04W 74/0875; H04W 76/10

(57) ABSTRACT

A method is provided. The method includes attaching a user device to a wireless network via a router of a first communications protocol. The method includes determining, based on information about a second session using a second communications protocol, a first time window and a second time window. The method includes determining to perform a first session using the first communications protocol in the first time window. The method includes performing a first arbitration between the first session and the second session. The method includes determining, based on the first arbitration, that the first session has a priority over the second session in the second time window. The method includes performing a second arbitration between the first session and a third session using a third communications protocol. The method includes determining, based on the second arbitration, whether to perform the first session in the second time window.

### CROSS-REFERENCE TO RELATED APPLICATIONS

This application claims priority to U.S. Provisional Patent Application No. 63/536,031, filed on Aug. 31, 2023, the content of which is incorporated herein by reference.

### BACKGROUND

Many electronic devices communicate with each other using wireless local area networks (WLANs), such as those based on a communication protocol that is compatible with an Institute of Electrical and Electronics Engineers (IEEE) standard, e.g., the IEEE 802.11 standard (also known as “WI-FI”). A WLAN typically includes an access point that provides one or more stations (STAs) with access to another network, such as the Internet. There are many generations of the IEEE 802.11 standard, including 802.11ax (WI-FI 6) and 802.11be (WI-FI 7). IEEE 802.11 communications can utilize a 2.4 GHz frequency band or other frequency bands (e.g., 5 GHz).

IEEE 802.11 is a packet-based protocol. Under this protocol, a transmitter, e.g., an access point (AP), transmits packaged control information or user data, e.g., protocol data units (PDUs), in a physical layer convergence protocol (PLCP). The PLCP PDU (PPDU) includes a preamble and a data field, among other fields. After generating the PPDU, the access point can send the PPDU to a station connected to the access point. Communication from the access point to a station is referred to as the downlink, and the communication from a station to the access point is referred to as the uplink.

In addition to IEEE 802.11, other technologies are often supported by some electronic devices. These technologies include BLUETOOTH and IEEE 802.15.4 (often implemented and known as “Thread”). BLUETOOTH and IEEE 802.15.4 communications can also utilize the 2.4 GHz frequency band.

### SUMMARY

This disclosure relates to the management of multiple coexisting communication protocols in a user device.

In accordance with one aspect of the present disclosure, a method is provided. The method includes attaching a user device to a wireless network via a router of a first communications protocol. The method includes determining, based on information about a second session using a second communications protocol, a first time window and a second time window. The method includes determining to perform a first session using the first communications protocol in the first time window. The method includes performing a first arbitration between the first session and the second session. The method includes determining, based on the first arbitration, that the first session has a priority over the second session in the second time window. The method includes performing a second arbitration between the first session and a third session using a third communications protocol. The method includes determining, based on the second arbitration, whether to perform the first session in the second time window.

In some implementations, the user device is configured with coordinated sampled listening (CSL). The method further includes controlling a CSL timer according to the time window and the second time window.

In some implementations, the user device is not configured with CSL. Determining the first time window and the second time window includes: obtaining the information about the second session from a wireless manager; and determining the first time window and the second time window using firmware of the first communications protocol.

In some implementations, determining to perform the first session in the first time window includes at least one of: determining that the user device is configured with CSL, determining that the third session operates on a first frequency band, or determining that the first session has a higher priority than the second session in the first time window.

In some implementations, determining whether to perform the first session in the second time window includes: determining a criticality level of the third session; and in response to determining that the third session is critical, determining not to perform the first session in the second time window.

In some implementations, determining whether to perform the first session in the second time window further includes: in response to determining that the third session is not critical, determining a criticality level of the first session; and performing at least one of: in response to determining that the third session is not critical and the first session is not critical, determining not to perform the first session in the second time window; and in response to determining that the third session is not critical and the first session is critical, determining to perform the first session in the second time window.

In some implementations, determining the criticality level of the first session includes determining an identifier of the first session.

In some implementations, the method further includes sending, from firmware of the first session to firmware of the third session, a request to perform the first session in the second time window.

In some implementations, the method further includes sending, from firmware of the third session to an access point of the third session, an indication of power reduction to occur in the first time window.

In some implementations, the method further includes before the attaching, performing a third arbitration between a fourth session using the first communications protocol and a fifth session using the second communications protocol; in response to determining that the fourth session has a priority over the fifth session, performing the fourth session; and in response to determining that the fifth session has a priority over the fourth session, performing the fifth session.

In some implementations, the router supports the first communications protocol and the third communications protocol.

In some implementations, the router is coupled to a synchronized sleepy end device.

In some implementations, the user device is attached to the wireless network indirectly via the router.

In some implementations, the wireless network includes one or more sleepy end devices that support the first communications protocol.

In some implementations, the first communications protocol includes an Institute of Electrical and Electronics Engineers (IEEE) 802.15.4 standard, the second communications protocol includes a BLUETOOTH standard, and the third communications protocol includes a WI-FI standard.

In accordance with one aspect of the present disclosure, a method is provided. The method includes establishing a link using a first communications protocol between a user device and a peer device. The method includes determining, based on information about a second session using a second communications protocol, a first time window and a second time window. The method includes determining to perform a first session via the link in the first time window. The method includes performing a first arbitration between the first session and the second session. The method includes determining, based on the first arbitration, that the first session has a priority over the second session in the second time window. The method includes performing a second arbitration between the first session and a third session using a third communications protocol. The method includes determining, based on the second arbitration, whether to perform the first session in the second time window. In some implementations, the peer device includes a synchronized sleepy end device.

Operations of the methods described above can be implemented as program instructions stored in a non-transitory computer-readable medium. A user device can have one or more processors that execute the program instructions to perform one or more operations.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a block diagram of example of electronic devices communicating wirelessly, according to some implementations.

FIGS. 2A-2C each illustrate a topology of an example Thread communications network, according to some implementations.

FIG. 3 illustrates an architecture of multiple coexisting protocols, according to some implementations.

FIGS. 4A-4B each illustrate an example two-stage arbitration process, according to some implementations.

FIGS. 5A and 5B each illustrate an example timing diagram for managing coexisting Thread and WI-FI protocols, according to some implementations.

FIGS. 6A and 6B each illustrate an example scenario with coexisting communication sessions, according to some implementations.

FIG. 7 illustrates an example arbitration process for coexisting WI-FI and Thread communications sessions on a user device, according to some implementations.

FIG. 8 illustrate a flowchart of an arbitration process for coexisting WI-FI and Thread communications sessions, according to some implementations.

FIGS. 9A and 9B each illustrate a flowchart of an example method, according to some implementations.

FIG. 10 illustrates a block diagram of an example electronic device, according to some implementations.

### DETAILED DESCRIPTION

More and more electronic devices today support all of the IEEE 802.11, BLUETOOTH, and IEEE 802.15.4 technologies for different applications. For example, a user may wear a wireless headphone paired with their mobile device using BLUETOOTH. The user may access a website using WI-FI and listen to music from the website using the headphone. Meanwhile, the user may use the mobile device to control a door lock or a window shade of their home using Thread. These activities can happen at approximately the same time using the same frequency resources. Accordingly, it is desirable to manage the coexistence of multiple communications sessions to improve communication quality and user experience.

This disclosure provides techniques to address these technical challenges. As described below in detail, implementations of this disclosure provide one or more arbitration-based mechanisms for a user device to determine whether to perform a communications session. By considering various factors, the one or more arbitration-based mechanisms cause minimal interruptions to high priority communications sessions while allowing deferral of low priority communications sessions. As such, implementations of this disclosure balance the communication needs from competing communications sessions and allow efficient use of communication resources to perform various tasks.

In the below description, WI-FI is used as a representative of IEEE 802.11 while Thread is used as a representative of IEEE 802.15.4. Furthermore, although the implementations described below are primarily in the context of coexistence of IEEE 802.11, BLUETOOTH, and IEEE 802.15.4, this disclosure is not limited to these three technologies. In some implementations, coexistence of different technologies are contemplated.

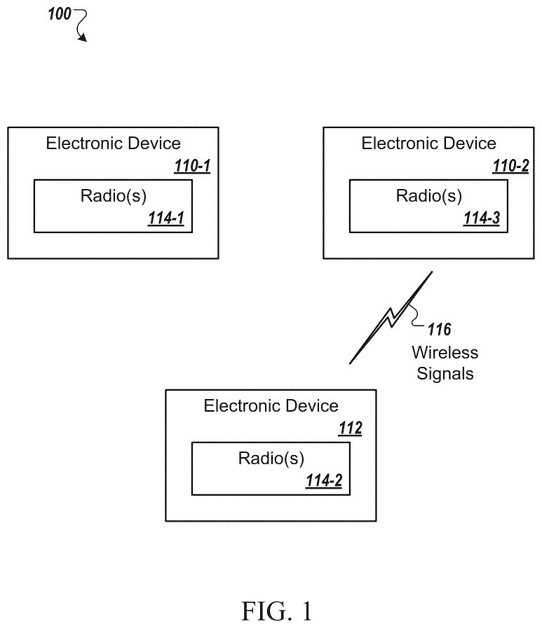

FIG. 1 illustrates a block diagram 100 of example of electronic devices communicating wirelessly, according to some implementations. Notably, one or more electronic devices 110 (such as a smartphone, a laptop computer, a notebook computer, a tablet, or another such electronic device) and access point 112 can communicate wirelessly in a WLAN using an IEEE 802.11 communication protocol. Thus, electronic devices 110 can be associated with or can have a connection with access point 112. For example, electronic devices 110 and access point 112 can wirelessly communicate while: detecting one another by scanning wireless channels, transmitting and receiving beacons or beacon frames on wireless channels, establishing connections (e.g., by transmitting connect requests), and/or transmitting and receiving packets or frames (which can include the request and/or additional information, such as data, as payloads). Note that the access point 112 can provide access to a network, such as the Internet, via an Ethernet protocol, and can be a physical access point or a virtual or “software” access point that is implemented on a computer or an electronic device. In this specification, electronic devices 110 are sometimes referred to as “recipient electronic devices” or “receiver stations.”

Although the environment shown in FIG. 1 is provided as an example, in alternative implementations, different numbers and/or types of electronic devices can be present. For example, some implementations can include more or fewer electronic devices. As another example, in some implementations, different electronic devices can be transmitting and/or receiving packets or frames. In some implementations, multiple links can be used during communication between electronic devices 110.

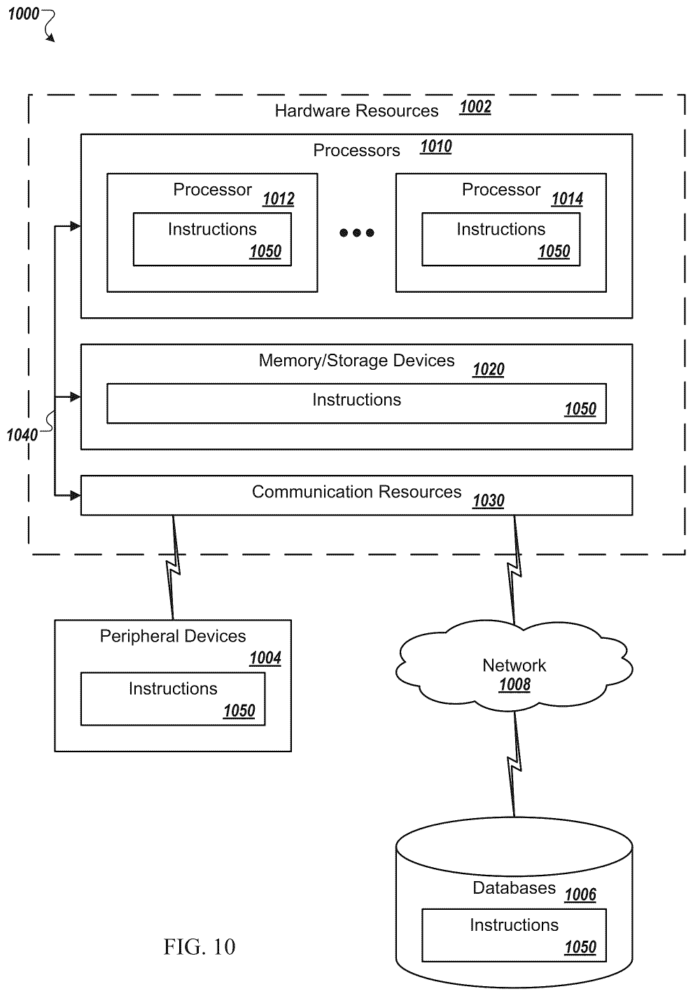

As described further below with reference to FIG. 10, electronic devices 110 and access point 112 can include subsystems, such as a networking subsystem, a memory subsystem, and a processor subsystem. In addition, electronic devices 110 and access point 112 can include radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacons on wireless channels to enable the electronic devices to make initial contact with or to detect each other, followed by exchanging subsequent data/management frames (such as connect requests) to establish a connection, configure security options, transmit and receive packets or frames via the connection, etc.

As shown in FIG. 1, wireless signals 116 are communicated by one or more radios 114-1 and 114-2 in electronic device 110-1 and access point 112, respectively. For example, as noted previously, electronic device 110-1 and access point 112 can exchange packets or frames using a Wi-Fi communication protocol in a WLAN. Further, one or more radios 114-1 can receive wireless signals 116 that are transmitted by one or more radios 114-2 via one or more links between electronic device 110-1 and access point 112. Alternatively, the one or more radios 114-1 can transmit wireless signals 116 that are received by the one or more radios 114-2.

In some implementations, wireless signals 116 are communicated by one or more radios 114 in electronic devices 110 and access point 112, respectively. For example, one or more radios 114-1 and 114-3 can receive wireless signals 116 that are transmitted by one or more radios 114-2 via one or more links between the electronic devices 110-1 and 110-2, and the access point 112.

In some implementations, the access point 112 can group the electronic devices 110 into a target station set. The target station set concept comes from downlink multi-user transmission where the access point 112 can transmit to multiple stations simultaneously in one PPDU using Orthogonal Frequency Division Multiple Access (OFDMA) or multiuser (MU) Multiple Input Multiple Output (MU-MIMO). Here, the target station set is a set of stations that can simultaneously be served by the access point 112. The stations in the set do not need to share the same PHY parameters, such as MCS, number of streams, etc.

In some implementations, the access point 112 can simultaneously communicate with a plurality of electronic devices 110 using multiuser (MU) techniques, such as MU Multiple Input Multiple Output (MU-MIMO). In some examples, the access point 112 communicates with the electronic devices 110 using frequency multiplexing such that the access point 112 allocates each of the electronic devices a portion of the overall bandwidth. For example, to simultaneously communicate with four electronic devices over an 80 Megahertz (MHz) bandwidth, the access point 112 transmits a MU-PPDU over the 80 MHz bandwidth. The MU-PPDU includes a sub-PPDU for each of the four electronic devices, where each sub-PPDU (or sub-channel) is allocated 20 MHz. The access point 112 can use the MU-PPDU to communicate with devices in the same target set, devices in different target sets, or a combination of both.

In some implementations, access point 112 and one or more electronic devices can be compatible with an IEEE 802.11 standard that includes trigger-based channel access, e.g., IEEE 802.11ax. In 802.11ax, Orthogonal Frequency Division Multiple Access (OFDMA) is used to enable simultaneous communications between the access point 112 and multiple electronic devices. OFDMA divides the available physical spectrum into multiple orthogonal sub-channels, or resource units (RUs), which can be allocated to different electronic devices (users). Under the standard, the access point 112 coordinates multiuser OFDMA by broadcasting a trigger frame which, among other things, allocates a RU to each participating electronic device. Each electronic device responds to the trigger frame by transmitting a PPDU to the access point 112 using the allocated RU. The trigger frame can also include power control information. The access point 112 can instruct all electronic devices 110 when to start and stop transmitting. Note that access point 112 and the electronic devices 110 can communicate with one or more legacy electronic devices that are not compatible with the IEEE 802.11 standard (i.e., that do not use multi-user trigger-based channel access).

In some implementations, processing a packet or frame in one of electronic devices 110 access point 112, or a combination of both, includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

As discussed previously, one or more of electronic devices 110 and access point 112 can communicate with each other. Notably, access point 112 can transmit a PPDU that includes a preamble and a data field. In some implementations, access point 112 can be configured to use concatenated PPDUs (C-PPDUs), e.g., for low latency communications with receiver stations. A C-PPDU includes a plurality of component PPDUs, each of which includes preamble and a data payload. As described in more detail below, the C-PPDU includes a plurality of component PPDUs. The first component PPDU is preceded by a first preamble called a “full preamble.” The remaining component PPDUs in the C-PPDU are each preceded by respective preambles that are shorter in length than the first preamble. In some implementations, the access point 112 might not perform contention or receive a block acknowledgement (BA) before the plurality of component PPDUs are transmitted.

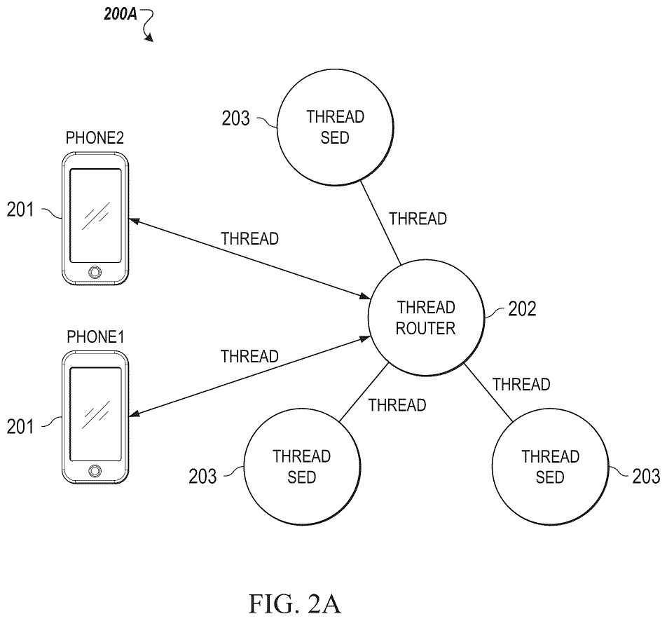

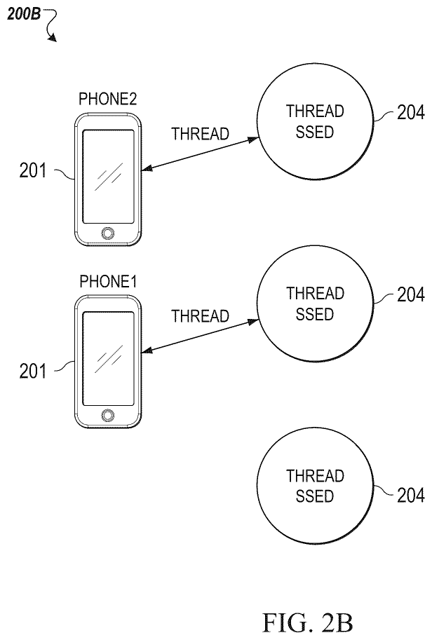

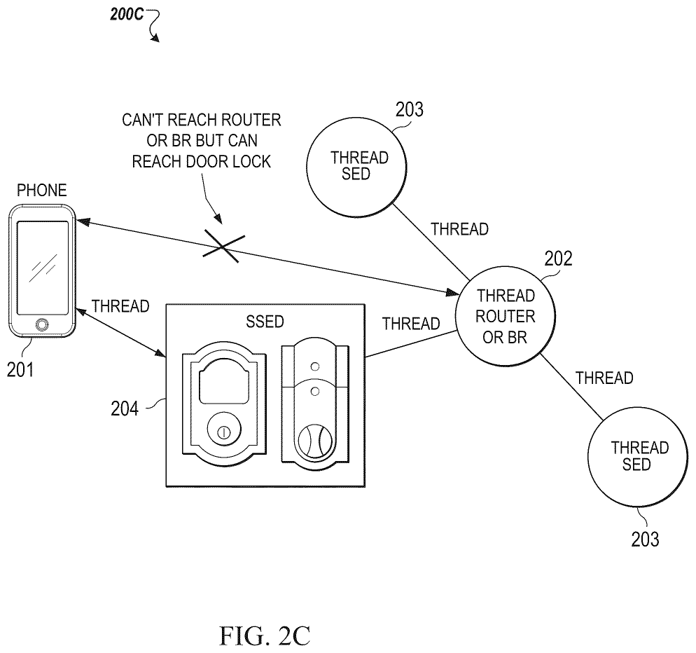

FIGS. 2A-2C each illustrate a topology of an example Thread communications network, 200A-200C, respectively, according to some implementations. Each of communications networks 200A-200C can have one or more electronic devices 110 of FIG. 1 that also supports IEEE 802.11 and/or BLUETOOTH communication protocols.

In communications network 200A, multiple user devices 201 establish communications sessions with Thread router 202. Via Thread router 202, each user device 202 can exchange Thread packets with one or more Thread sleepy end devices (SEDs) 203. By establishing the communications sessions with Thread router 202, each user device 201 is attached to communications network 200A as, e.g., a synchronized SED (SSED). For example, a smartphone that supports Thread can be used as a remote control of home appliance (e.g., lamps). When the user wants to adjust the lamps, the user can activate a Thread communications session, and, via Thread router 202, control one or more lamps, which function as SEDs 203. In some implementations, Thread router 202 can be the same or be included within a WI-FI router that connects to one or more devices via WI-FI links.

In communications network 200B, each of user devices 201 communicates with a peer device, such as a corresponding Thread SSED 204. Different from communications network 200A in which a user device can exchange Thread traffic with multiple Thread SEDs, each user device 201 in communications network 200B establishes a one-to-one link to its corresponding Thread SSED 204. In this topology, each user device 201 can function as a Thread SSED or a sleepy router that activates only when triggered. For example, the user device can activate only when it is located within the coverage of its corresponding Thread SSED 204, such as within a distance from the user's home.

In communications network 200C, user device 201 is unable to establish a Thread link directly to Thread router (or border router) 202 due to reasons such as network security setting, distance, physical barrier, etc. However, user device 201 is able to establish a Thread link to Thread SSED 204, and, via Thread SSED 204, establish a Thread link to router (or border router) 202 indirectly. As such, user device 201 can still attach to the Thread network including Thread SEDs 203. As an example scenario, a user holding user device 201 outside the user's home may be unable to directly attach to the user's home Thread network via Thread router 202. However, via the user's door lock that has Thread capabilities, user device 201 can indirectly attach to the home Thread network and establish communications sessions with Thread SEDs 203, such as lamps, within the home Thread network.

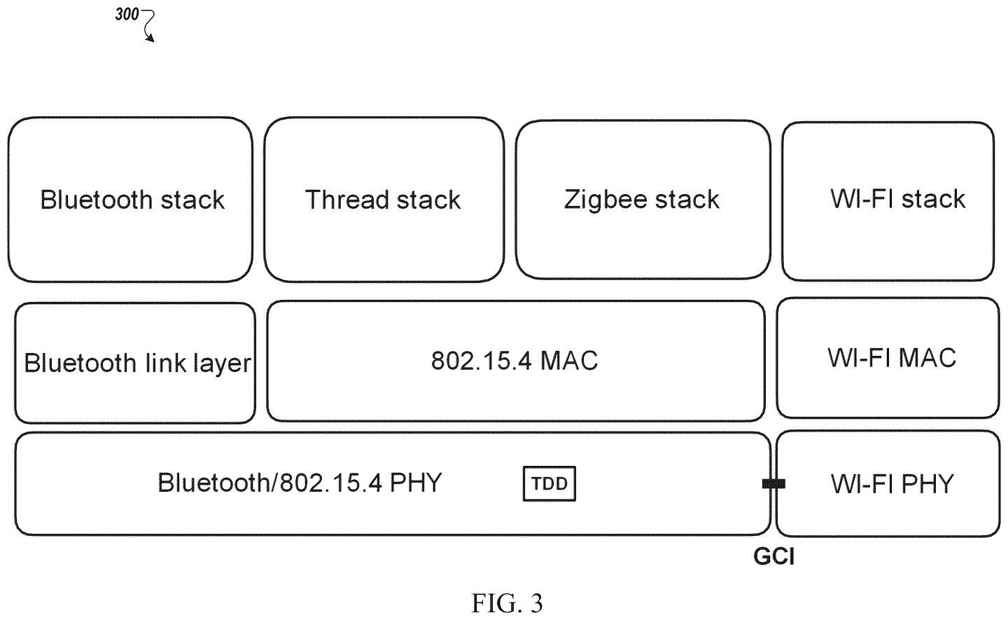

FIG. 3 illustrates a network architecture 300 of multiple coexisting protocols, according to some implementations. Network architecture 300 can be adopted by electronic devices 110 of FIG. 1 or user device 201 of FIGS. 2A-2C.

Network architecture 300 includes at least three layers. At the lowest is the physical (PHY) layer. Above PHY layer is the data link layer or the medium access control (MAC) layer. Further above the MAC layer is the network layer.

At the PHY layer, BLUETOOTH and IEEE 802.15.4 can use the same PHY layer module (e.g., hardware and software) to transmit and receive physical radio signals on a time division duplex (TDD) basis, depending on priority levels of the BLUETOOTH and IEEE 802.15.4 communications sessions. In addition, WI-FI can have its own PHY layer module communicatively coupled to the PHY layer module shared by BLUETOOTH and IEEE 802.15.4. Through a global Coex interface (GCI), the WI-FI PHY module and the BLUETOOTH/IEEE 802.15.4 PHY module can exchange information about coexistence management. For example, the WI-FI PHY module can receive a request to communicate from the BLUETOOTH/IEEE 802.15.4 PHY module and determine whether to grant the request. In some implementations, the BLUETOOTH/IEEE 802.15.4 PHY module communicates under the BLUETOOTH or IEEE 802.15.4 protocol in a corresponding communications session only when the communication is granted by the WI-FI PHY module. The WI-FI PHY module can apply the same policy for BLUETOOTH and IEEE 802.15.4 communications when determining whether to grant a request.

Each of the BLUETOOTH, IEEE 802.15.4, and WI-FI protocols can have a corresponding data link layer module or a MAC module. The data link layer module or the MAC module can include functions to process data or control signals according to the corresponding protocol. The BLUETOOTH and WI-FI protocols can also have a corresponding network layer module, which can include a collection of network functions as specified by the corresponding protocol. The IEEE 802.15.4 can have one or more network layer modules, such as a Thread module and a ZIGBEE module, both of which are standards based on the IEEE 802.15.4 protocol.

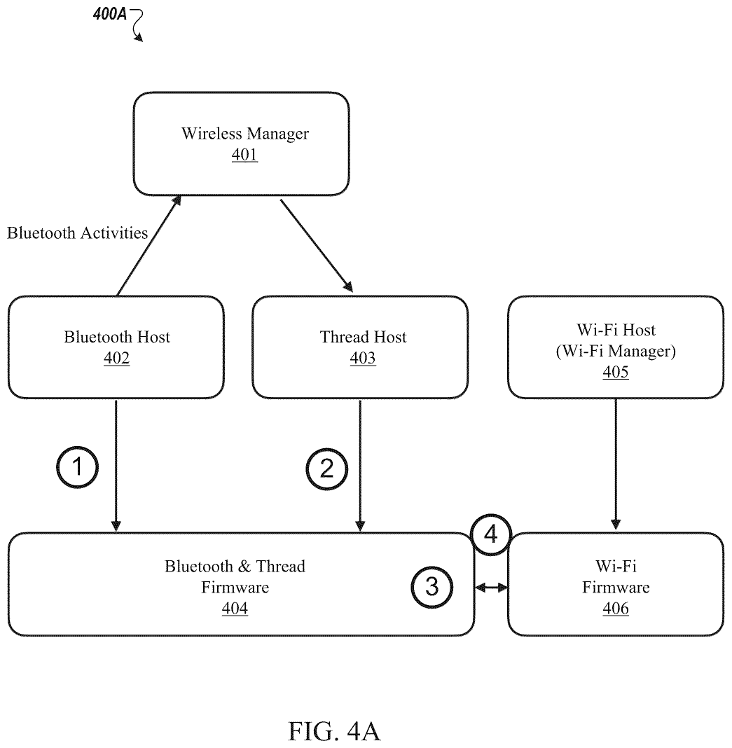

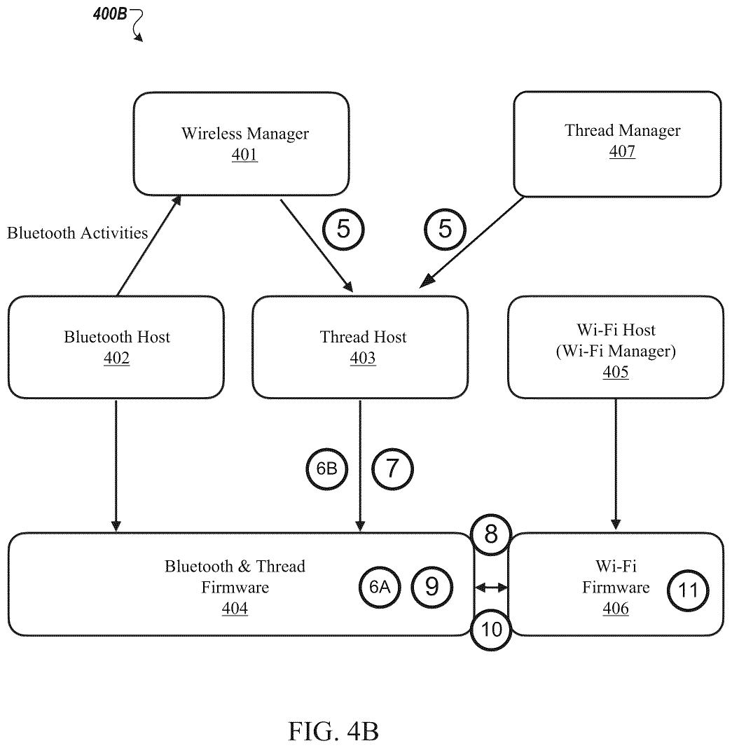

FIGS. 4A-4B each illustrate an example two-stage arbitration process, 400A and 400B, respectively, according to some implementations. Processes 400A and 400B can be performed between or within functional or structural blocks of electronic devices 110 of FIG. 1 or user device 201 of FIGS. 2A-2C.

Process 400A can be performed by a user device that has wireless manager 401, BLUETOOTH host 402, Thread host 403, firmware 404 shared by BLUETOOTH and Thread, WI-FI host (also referred to as WI-FI Manager) 405, and WI-FI firmware 406. Among these blocks, wireless manager 401 can obtain information about BLUETOOTH communications activities from BLUETOOTH host 402 and control the operations of Thread host 403.

At operation 1, BLUETOOTH host 402 obtains (e.g., from wireless manager 401) priority information about Thread tasks and passes the priority information to BLUETOOTH and Thread firmware 404. The priority information, which can be formatted as a table, can indicate priority levels of different types of Thread traffic. For example, Thread traffic that controls the locking/unlocking of a door may have higher priority over Thread traffic that controls the opening/closing of a window shade. BLUETOOTH host 402 can obtain the priority information upon initialization of the user device.

At operation 2, Thread host 403 selects, based on the type of Thread traffic, a priority level relative to BLUETOOTH activities. Thread host 403 then passes the priority level information to BLUETOOTH and Thread firmware 404. Thread host 403 can obtain the priority level at runtime (e.g., when there is active BLUETOOTH and Thread traffic to and from the user device).

At operation 3, BLUETOOTH and Thread firmware 404 performs an arbitration based on the priority levels of a requested BLUETOOTH communications session and a requested Thread communications session. For example, if the Thread communications session is of higher priority than the BLUETOOTH communications session, then firmware 404 can determine to allow the Thread communications session to execute first, and allow the BLUETOOTH communications session to execute only when it does not interfere the high priority Thread communications session.

At operation 4, the Thread communications session, if determined to have high priority over BLUETOOTH, raises a request to WI-FI firmware 406. For example, even if BLUETOOTH and Thread firmware 404 allows the Thread communications session to execute, WI-FI firmware 406 may determine that the WI-FI traffic is critical or of higher priority than the requested Thread traffic, in which case WI-FI firmware 406 denies the request raised for the Thread communications session. WI-FI firmware 406 can obtain information relating to the WI-FI traffic from WI-FI host 405.

Moving to process 400B, the process can be performed by a user device that similarly has blocks 401-406 described with reference to process 400A. The user device can additionally have Thread manager 407 that stores application-related information about the Thread traffic. For example, Thread manager 407 can be a hub of a Thread home network that wirelessly connects appliances, door locks, window shades, and other devices.

At operation 5, Thread host 403 obtains, from wireless manager 401, information about the load of current BLUETOOTH communications sessions. Thread host 403 also obtains, from Thread manager 407, application-related information about the Thread traffic.

At operation 6 (illustrated as one of 6A and 6B), a first time window and a second time window are determined. Specifically, if Thread host 403 determines that the user device is configured with Thread version 1.2 or later, which supports coordinated sampled listening (CSL), then, at operation 6A, firmware 404 determines the length of the first time window and the length of the second time window as attributes of a CSL information element (IE). Conversely, if Thread host 403 determines that the user device is configured with Thread version 1.1 or earlier, which does not support CSL, then, at operation 6B, Thread host 403 determines the length of the first time window and the length of the second time window and sends the determined lengths to firmware 404.

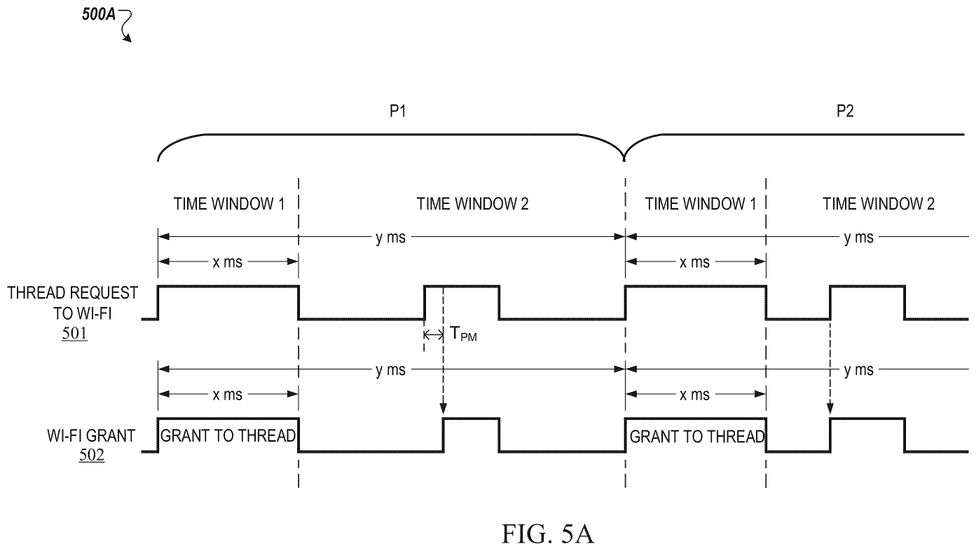

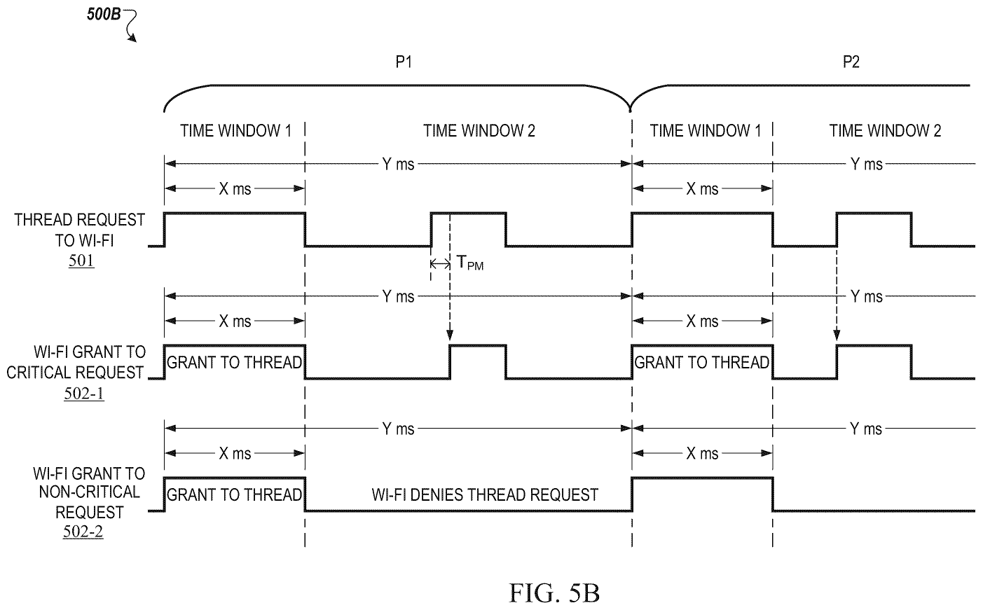

The length of the first time window and the length of the second time window can be represented by two parameters. In some implementations, the length of the first time window is represented by a value of x millisecond (ms), while the length of the second time window is represented by a value of (y-x) ms (i.e., y minus x). Here, the value of y can indicate a periodicity at which firmware 404 makes a communication request to WI-FI firmware 406, while the value of x can indicate a duration within a period of y reserved for the requested communication. Detailed description of the parameters x and y will be provided later with reference to FIGS. 5A-8.

The determination at operations 6A and 6B can be based on information about BLUETOOTH communications sessions, such as the load of current BLUETOOTH communications sessions. For example, when the load is relatively high, then x and y can be relatively small. When the load is relatively high, then x and y can be relatively large.

At operation 7, Thread host 403 determines a criticality level of the requested Thread communications session and passes the determined criticality level to firmware 404. The determination can be based on, e.g., application-related information about the Thread traffic. For example, when the user device sends Thread traffic to unlock a door of the user's home, the Thread communications session can be considered critical. On the other hand, when the user device receives routine status updates from one of many lamps connected to a Thread home network, the communications session can be considered non-critical. In some implementations, the criticality level can be represented by an identifier (ID) of a session. For example, critical Thread sessions can have session IDs equal to 0 while non-critical Thread sessions can have session IDs greater than 0.

At operation 8, firmware 404 sends the parameters x and y to WI-FI firmware 406 via a GCI. With knowledge of x and y, WI-FI firmware 406 can predict when a communication request for Thread communication will be raised. By making the prediction, WI-FI firmware 406 can plan its own WI-FI communications sessions ahead of time by, e.g., informing a corresponding access point (AP) to reduce data rate and switch to a power reduction mode, such that frequency resources are freed up for the Thread communication session.

At operation 9, firmware 404 performs an arbitration between the BLUETOOTH communications session and the Thread communication session based on priority levels of the two sessions. From the arbitration, firmware 404 can schedule, on a TDD basis, the BLUETOOTH communications session and/or the Thread communication session.

At operation 10, if the Thread communication session is scheduled (e.g., due to higher priority than the BLUETOOTH communications session), firmware 404 raises a request to WI-FI firmware 406. In some implementations, the request is raised in each of the first time window and the second time window.

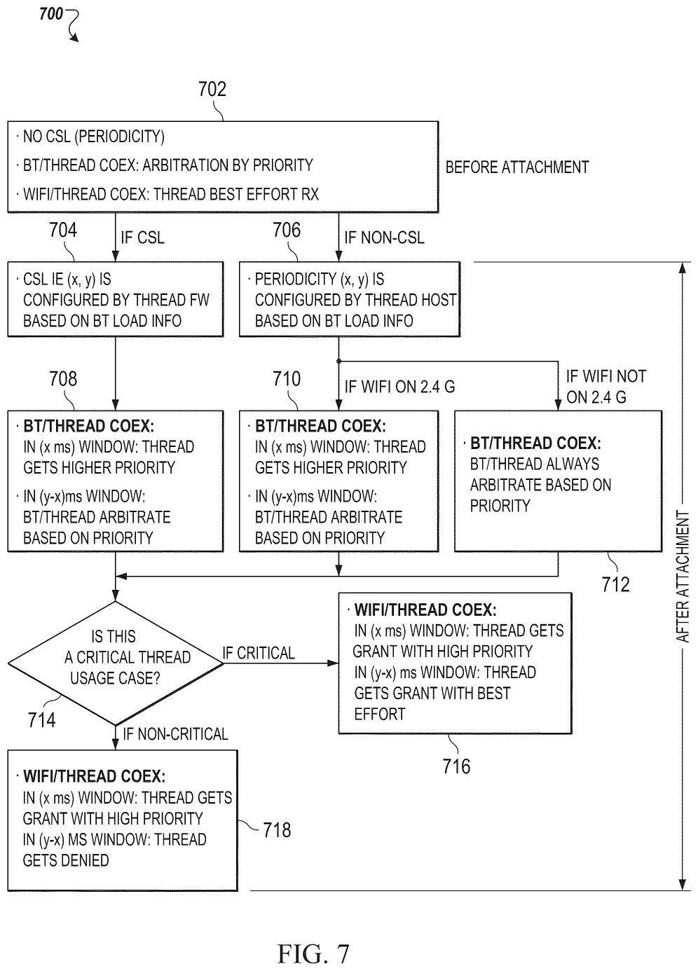

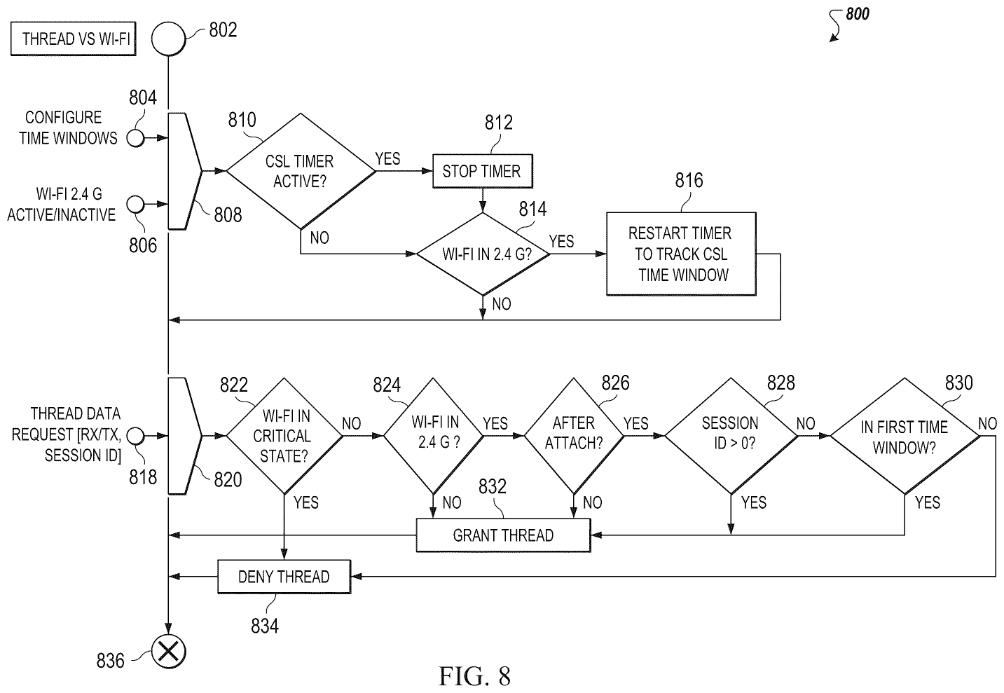

At operation 11, WI-FI firmware 406 performs an arbitration between the existing WI-FI communications session and the requested Thread communication session based on, e.g., levels of criticality. WI-FI firmware 406 can grant or deny the requested Thread communication session based on the arbitration outcome. Detailed information of the arbitration between WI-FI and Thread will be provided below with reference to FIGS. 7 and 8.

It is noted that operations 1-4 of process 400A and operations 5-8 of process 400B can take place before or without the user device's attachment to a Thread/WI-FI network. For example, even when a user is located outside the coverage of the Thread/WI-FI network of the user's home, the user device can perform these operations to prepare for an upcoming attachment. On the other hand, operations 9-11 can take place after attachment.

More generally, in some implementations, the user device is not configured with the first and second time windows before attachment. To manage coexistence of BLUETOOTH, Thread, and WI-FI, the user device can perform an arbitration between BLUETOOTH and Thread based on priority level. If Thread wins the arbitration, the user device can perform the Thread communications on a best-effort basis, without seeking the grant of WI-FI. This mechanism does not cause much disruption to WI-FI because the user device is not yet attached to a WI-FI network.

FIG. 5A illustrates an example timing diagram 500A for managing coexisting Thread and WI-FI protocols, according to some implementations. Timing diagram 500A can apply to a scenario where a user device has been attached to a Thread/WI-FI network and has been configured with the first and second time windows (shown as time window 1 and time window 2 in timing diagram 500A), lasting x ms and (y-x) ms, respectively.

As shown in timing diagram 500A, time window 1 and time window 2 repeat periodically every y ms. Within time window 1, Thread firmware asserts a Request signal 501 that requests WI-FI firmware to grant a Thread communications session. Meanwhile, because WI-FI firmware has already obtained information about time window 1 and time window 2 (e.g., at operation 8 of FIG. 4B), the WI-FI firmware is able to predict the assertion of the Request signal 501 and grant the request Thread communications session within time window 1. That is, the WI-FI firmware can assert a Grant signal 502 to accommodate the requested Thread communications session. To avoid interference, the WI-FI firmware can inform other connected WI-FI devices, such as a WI-FI access point, to switch to a power reduction mode ahead of the assertion of the Grant signal 502.

Continuing with timing diagram 500A, in time window 2, the Request signal 501 from Thread can come without notice to WI-FI, and the WI-FI firmware can grant the requested Thread communications session on a best effort basis (e.g., under the condition that ongoing WI-FI communications sessions are able to accommodate the requested Thread communications session). Assuming the Request signal 501 is first received by WI-FI in period P1, the WI-FI firmware may take time T_{PM} to inform the WI-FI access point to switch to a power reduction mode. In this case, the assertion of the Grant signal 502 lags behind the assertion of the Request signal 501 by T_{PM} in period P1. Because the WI-FI access point has already switched to the power reduction mode in period P1, in later periods (e.g., P2) the assertion of the Grant signal 502 can happen at about the same time as the assertion of the Request signal 501.

FIG. 5B illustrates another example timing diagram 500B for managing coexisting Thread and WI-FI protocols, according to some implementations. Timing diagram 500B can apply to a scenario where a user device has been attached to a Thread/WI-FI network and has been configured with the first and second time windows (shown as time window 1 and time window 2 in timing diagram 500B), lasting x ms and (y-x) ms, respectively. Different from timing diagram 500A, WI-FI firmware that implements timing diagram 500B can take into account a criticality level of the requested Thread communications session, as explained below.

Within time window 1, Thread firmware asserts a Request signal 501 that requests WI-FI firmware to grant a Thread communications session. Similar to timing diagram 500A, the WI-FI firmware can assert a Grant signal 502 (shown as 502-1 and 502-2) to accommodate the requested Thread communications session, regardless of the criticality level of the requested Thread communications session.

Within time window 2, the Request signal 501 from Thread can come without notice to WI-FI. If the WI-FI firmware determines that the requested Thread communications session is critical (e.g., with higher priority than WI-FI), then the WI-FI firmware can assert a grant signal 502-1 to grant the requested Thread communications session to proceed on a best effort basis, similar to the grant described in timing diagram 500A. However, if the WI-FI firmware determines that the requested Thread communications session is non-critical (e.g., with lower priority than WI-FI), then the WI-FI firmware can deny the request by not asserting the grant signal 502-2. Compared with the coexistence management mechanism in timing diagram 500A, the mechanism in timing diagram 500B can better balance the communication needs between WI-FI and Thread, can advantageously improve communication efficiency and user experience.

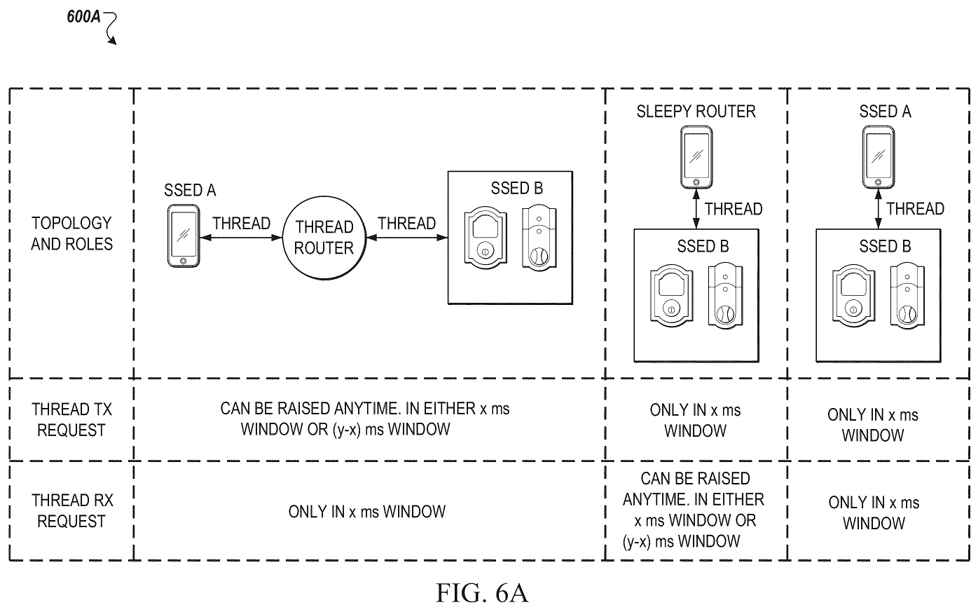

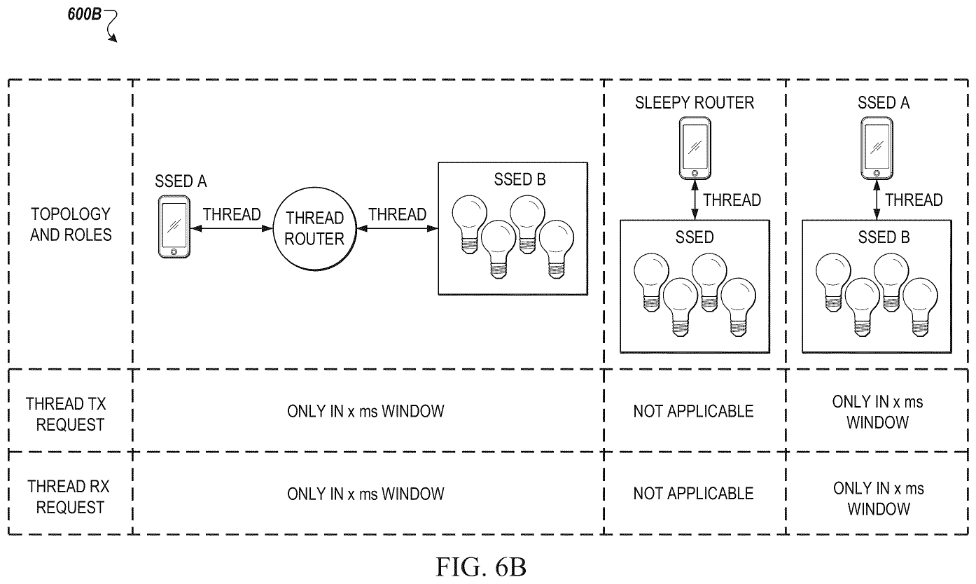

FIGS. 6A and 6B each illustrate an example scenario, 600A and 600B, respectively, with coexisting communication sessions on a user device, according to some implementations. The Thread communications session in scenario 600A can be at least partially critical (e.g., the user device controlling a door lock), and the Thread communications session in scenario 600B can be non-critical (e.g., the user device controlling a light bulb among many light bulbs). For each scenario, three possible network topologies or roles of the user device are illustrated: i) Similar to the illustration of communications network 200A, the user device communicates with an SSED B via a Thread router, where the user device functions as a SSED A; ii) Similar to the illustration of communications network 200B, the user device communicates with an SSED B in a one-to-one link, where the user device functions as a sleepy router; and iii) Also similar to the illustration of communications network 200B, the user device communicates with an SSED B in a one-to-one link, where the user device functions as a SSED A.

In scenario 600A, under topology i), the transmission (TX) from the user device to the Thread router can be critical but the reception (RX) at the user device from the Thread router can be non-critical. Accordingly, a request to communicate on the TX link of the Thread communications session can be raised and granted any time during the first time window and the second time window, but a request to communicate on the RX link may be granted only during the first time window and may be denied by WI-FI firmware in the second time window due to non-criticality (as described above with reference to timing diagram 502-2). Under ii), the user device acting as a sleepy router can forward control signaling from another user device to control the SSED B. As such, the TX from the sleeper router to the SSED B can be non-critical while the RX from the SSED B to the sleeper router can be critical. Accordingly, a request to communicate on the TX link may be granted only during the first time window and yet a request to communicate on the RX link can be raised and granted any time during the first time window and the second time window. Under iii), both the TX and the RX between the user device acting as a SSED A and the corresponding linked SSED B can be non-critical. Accordingly, only a request to transmit or receive during the first time window may be granted.

In scenario 600A, under topologies i) and iii), both the TX and the RX between the user device acting as a SSED A and the SSEDs B can be non-critical. Accordingly, only a request to transmit or receive during the first time window may be granted. With respect to topology ii), it is assumed this topology does not apply to scenario 600A where a user device acts as a sleepy router to allow another user device to control light bulbs SSEDs.

FIG. 7 illustrates an example process 700 for managing coexisting BLUETOOTH, WI-FI and Thread communications sessions, according to some implementations. Process 700 include operation 702 that can be performed before a user device is attached to a Thread/WI-FI network and operations 704-718 that can be performed after a user device is attached to the Thread/WI-FI network. The user device that performs process 700 can be similar to electronic devices 110 of FIG. 1 or user device 201 of FIGS. 2A-2C.

At 702, the user device manages coexisting communications sessions before attachment. At this stage, the CSL feature of the user device is not available or not activated, and the user device does not determine the first and second time windows. Rather, the user device performs an arbitration between BLUETOOTH and Thread to schedule BLUETOOTH and Thread communications sessions on a TDD basis. The WI-FI firmware can grant the scheduled Thread communications session on a best effort basis. These operations can be similar to operations 1-4 in FIG. 4A.

After the user device is attached to a Thread/WI-FI network, process 700 proceeds either to 704 in scenarios where the user device supports CSL or to 706 in scenarios where the user device does not support CSL. At 704, Thread firmware configures a CSL IE with the values x and y to indicate the first and second time windows. The values x and y can be determined based on BLUETOOTH (BT) load information. Then, at 708, the Thread communications session is given or assumed to have higher priority than the BLUETOOTH communications session during the first time window, and yet a priority-based arbitration is performed between BLUETOOTH and Thread to determine which communications session should be performed during the second time window. In other words, the user device is configured to favor the Thread communications session over the BLUETOOTH communications session during the first time window, but to arbitrate between the two communications sessions based on priority during the second time window.

At 706 and different from 704, the Thread host, instead of the Thread firmware, configures the values x and y. Afterwards, if the coexisting WI-FI communications session uses the 2.4 GHz band (at 710), then, similar to 708, the user device is configured to favor the Thread communications session over the BLUETOOTH communications session during the first time window, but arbitrates between the two communications sessions based on priority during the second time window. On the other hand, if the coexisting WI-FI communications session uses a different band than the 2.4 GHz band (at 712), then the Thread and BLUETOOTH communication sessions do not have to share the 2.4 GHz band with WI-FI. As such, the user device is configured to arbitrate between the Thread and BLUETOOTH communications sessions based on priority, regardless of time windows.

After any of 708, 710, and 712, the user device determines at 714 whether the Thread communications session is critical. If the Thread communications session is critical, then, at 718, the WI-FI firmware grants the Thread communications session in the first time window but denies the Thread communications session in the second time window. Conversely, if the Thread communications session is critical, then, at 716, the WI-FI firmware grants the Thread communications session as having high priority in the first time window, while granting the Thread communications session on a best effort basis in the second time window. The operations at 714-716 can involve a Request signal and a Grant signal similar to signals 501 and 502 described above with reference to FIG. 5B.

FIG. 8 illustrate a flowchart of an arbitration process 800 for coexisting WI-FI and Thread communications sessions, according to some implementations. Process 800 can be performed by a user device that is similar to electronic devices 110 of FIG. 1 or user device 201 of FIGS. 2A-2C. Process 800 assumes the user device supports CSL.

Arbitration process 800 starts at 802, after an arbitration performed by the BLUETOOTH and Thread firmware that determines Thread is of higher priority than BLUETOOTH. Thus, from 804 to 836, another arbitration is performed by the WI-FI firmware between Thread and WI-FI.

At 804, the user device configures the first and second time windows. At 806, the user device determines whether its ongoing WI-FI communications session operates on the 2.4 GHz band or different bands. The determined first and second time windows and the information about WI-FI frequency band are provided to the WI-FI firmware at 808.

At 810, the WI-FI firmware determines whether a CSL timer is currently active. If the CSL timer is active, the WI-FI firmware stops the timer at 812.

At 814, the WI-FI firmware makes a determination based on the frequency band of the WI-FI communications session. If the WI-FI communications session operates on the 2.4 GHz band, then the WI-FI firmware restarts the CSL timer according to the determined first and second time windows. If the WI-FI communications session does not operate on the 2.4 GHz band, then the WI-FI firmware can proceed with the Thread/WI-FI arbitration regardless of time windows. In this case, the WI-FI firmware does not need to restart the CSL timer and can directly proceed to 818.

At 818, the WI-FI firmware receives a communication Request signal from the Thread firmware. The Request signal can indicate whether the requested communication is for TX or RX and provide a session ID of the requested Thread communications session. As described above, the session ID can indicate the criticality level of the requested Thread communications session.

At 822-830, a series of judgements are made to determine whether the requested Thread communications session should be granted at 832 or denied at 834. Specifically, at judgement 822, if the ongoing WI-FI communications session is in a critical state (e.g., should not be interrupted), then the requested Thread communications session is denied; otherwise the arbitration proceeds to 824. At judgement 824, if the ongoing WI-FI communications session does not operate on the 2.4 GHz band, then the requested Thread communications session is granted; otherwise the arbitration proceeds to 826. At judgement 826, if the user device has not been attached to a Thread/WI-FI network, then the requested Thread communications session is granted; otherwise the arbitration proceeds to 828. At judgement 828, if the session ID is greater than 0 (which indicates the requested Thread communications session is critical), then the requested Thread communications session is granted; otherwise the arbitration proceeds to 830. At 830, if the requested Thread communications session is scheduled to occur within the first time window, then the requested Thread communications session is granted; otherwise the requested Thread communications session is denied.

Arbitration process 800, along with above-described arbitration processes between Thread and BLUETOOTH, together provide balanced management of coexisting BLUETOOTH, WI-FI, and Thread communication needs. For example, when the WI-FI communications session is critical, the Thread communication is denied such that the WI-FI communications session remain uninterrupted. Otherwise, when the WI-FI communications session is non-critical, the arbitration considers various factors to determine whether and when to grant the requested Thread communications session. Accordingly, the needs for BLUETOOTH, WI-FI and Thread communications are all accounted for, and the user device can improve the overall communication performance without unnecessarily sacrificing the efficiency of an individual communication session.

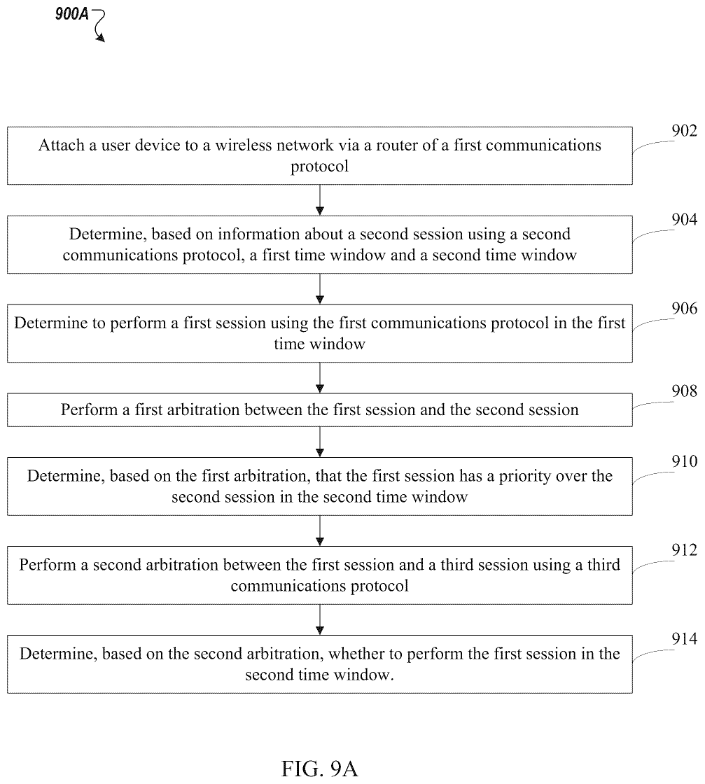

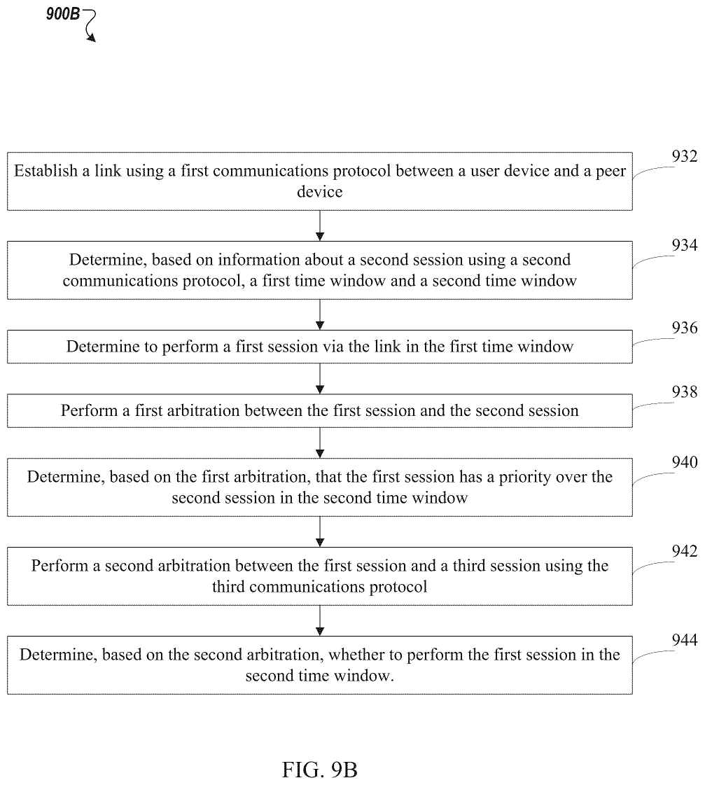

FIGS. 9A and 9B each illustrate a flowchart of an example method, 900A and 900B, respectively, according to some implementations. For clarity of presentation, the description that follows generally describes methods 900A and 900B in the context of the other figures in this description. For example, methods 900A and 900B can be performed by electronic devices 110 of FIG. 1 or user device 201 of FIGS. 2A-2C. It will be understood that methods 900A and 900B can be performed, for example, by any suitable system, environment, software, hardware, or a combination of systems, environments, software, and hardware, as appropriate. In some implementations, various steps of each of methods 900A and 900B can be run in parallel, in combination, in loops, or in any order. Method 900A can be performed in a network that has a topology similar to those of communications networks 200A or 200C. Method 900B can be performed in a network that has a topology similar to that of communications network 200B.

Starting from method 900A, at 902, a user device is attached to a wireless network via a router of a first communications protocol. The first communications protocol can be, e.g. Thread.

At 904, the user device determines a first time window and a second time window based on information about a second session using a second communications protocol. The second communications protocol can be, e.g., BLUETOOTH.

At 906, the user device determines to perform a first session using the first communications protocol in the first time window. The first session can be, e.g., a Thread communications session.

At 908, the user device performs a first arbitration between the first session and the second session. The first arbitration can be performed by the firmware shared by the first session and the second session.

At 910, the user device determines, based on the first arbitration, that the first session has a priority over the second session in the second time window. In some implementations, the first session can then send a Request signal to the firmware of a third session, which can be, e.g., a WI-FI communications session.

At 912, the firmware of the third session performs a second arbitration between the first session and a third session using a third communications protocol, such as WI-FI. The second arbitration can consider a variety of factors, such as a criticality level of the first session, a criticality level of the third session, and a frequency band of the third session. The second arbitration can include one or more operations of arbitration process 800 of FIG. 8.

At 914, the user device determines, based on the second arbitration, whether to perform the first session in the second time window. The determination can be performed by the firmware of the third session, which can grant or deny the communication request of the first communications session.

Moving to method 900B, at 932, a link is established between a user device and a peer device using a first communications protocol. The link can be a one-to-one link using, e.g., the Thread protocol.

At 934, the user device determines a first time window and a second time window based on information about a second session using a second communications protocol. Similar to 904 of method 900A, the second communications protocol of method 900B can be, e.g., BLUETOOTH.

At 936, the user device determines to perform a first session via the link in the first time window. The first session can be, e.g., a Thread communications session.

At 938, the user device performs a first arbitration between the first session and the second session. The first arbitration can be performed by firmware shared by the first session and the second session.

At 940, the user device determines, based on the first arbitration, that the first session has a priority over the second session in the second time window. In some implementations, the first session can then send a Request signal to the firmware of a third session, which can be, e.g., a WI-FI communications session.

At 942, the user device performs a second arbitration between the first session and a third session using a third communications protocol, such as WI-FI. The second arbitration can be performed by the firmware of the third session and consider a variety of factors, such as a criticality level of the first session, a criticality level of the third session, and a frequency band of the third session. The second arbitration can include one or more operations of arbitration process 800 of FIG. 8.

At 944, the user device determines, based on the second arbitration, whether to perform the first session in the second time window. The determination can be performed by the firmware of the third session, which can grant or deny the communication request of the first communications session.

FIG. 10 illustrates a block diagram of an electronic device 1000, according to some implementations. The electronic device 1000 can be a cellular telephone, a smartwatch, an access point, a wireless speaker, an Internet-of-Things (IoT) device, among other examples. The electronic device 1000 includes hardware resources 1002 that include one or more processors (or processor cores) 1010, one or more memory/storage devices 1020, and one or more communication resources 1030, each of which can be communicatively coupled via a bus 1040. The electronic device 1000 can have hardware, software, and firmware that support and manage coexistence of multiple communication protocols according to one or more implementations described above.

The one or more processors 1010 include one or more devices configured to perform computational operations. For example, the one or more processors 1010 can include one or more microprocessors, application-specific integrated circuits (ASICs), microcontrollers, graphics processing units (GPUs), programmable-logic devices, and/or one or more digital signal processors (DSPs). The processors 1010 can include, for example, a processor 1012 and a processor 1014. The processor(s) 1010 can be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1020 can include main memory, disk storage, or any suitable combination thereof. The memory/storage devices 1020 can include, but are not limited to, any type of volatile or nonvolatile memory such as dynamic random-access memory (DRAM), static random-access memory (SRAM), erasable programmable read-only memory (EPROM), electrically erasable programmable read-only memory (EEPROM), Flash memory, solid-state storage, etc. In some implementations, the memory/storage devices 1020 are coupled to one or more high-capacity mass-storage devices (not shown). In some examples, memory/storage devices 1020 can be coupled to a magnetic or optical drive, a solid-state drive, or another type of mass-storage device. In these examples, the memory/storage devices 1020 can be used by electronic device 1000 as fast-access storage for often-used data, while the mass-storage device is used to store less frequently used data.

The communication resources 1030 can include interconnection or network interface components or other suitable devices to communicate with one or more peripheral devices 1004 or one or more databases 1006 via a network 1008. For example, the communication resources 1030 can include wired communication components (e.g., for coupling via USB), cellular communication components, NFC components, Bluetooth® (or Bluetooth® Low Energy) components, Wi-Fi® components, and other communication components.

The communication resources 1030 include one or more devices configured to couple to and communicate on a wired and/or wireless network (i.e., to perform network operations), such as: control logic, one or more interface circuits and a set of antennas (or antenna elements) in an adaptive array that can be selectively turned on and/or off by control logic to create a variety of optional antenna patterns or “beam patterns.” Alternatively, instead of the set of antennas, in some examples, electronic device 1000 includes one or more nodes, e.g., a pad or a connector, which can be coupled to the set of antennas. Thus, electronic device 1000 might or might not include the set of antennas. For example, communication resources 1030 can include a Bluetooth™ networking system, a cellular networking system (e.g., a 3G/4G/5G/6G network such as UMTS, LTE, etc.), a universal serial bus (USB) networking system, a networking system based on the standards described in IEEE 802.11 (e.g., a Wi-Fi® networking system), an Ethernet networking system, and/or another networking system.

In some implementations, communication resources 1030 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

The communication resources 1030 include processors, controllers, radios/antennas, sockets/plugs, and/or other devices used for coupling to, communicating on, and handling data and events for each supported networking system. Note that mechanisms used for coupling to, communicating on, and handling data and events on the network for a network system are sometimes collectively referred to as a “network interface” for the network system.

Instructions 1050 can include software, a program, an application, an applet, an app, or other executable code for causing at least any of the processors 1010 to perform any one or more of the methodologies discussed herein. The instructions 1050 can reside, completely or partially, within at least one of the processors 1010 (e.g., within the processor's cache memory), the memory/storage devices 1020, or any suitable combination thereof. In some implementations, any portion of the instructions 1050 can be transferred to the hardware resources 1002 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

While the preceding discussion used a Wi-Fi communication protocol as an illustrative example, in other implementations a wide variety of communication protocols and, more generally, wireless communication techniques can be used. Thus, the communication techniques can be used in a variety of network interfaces. Furthermore, while some of the operations in the preceding implementations were implemented in hardware or software, in general the operations in the preceding implementations can be implemented in a wide variety of configurations and architectures. Therefore, some or all of the operations in the preceding implementations can be performed in hardware, in software or a combination of both. For example, at least some of the operations in the communication techniques can be implemented using instructions 1050, operating system (such as a driver for an interface circuit in communication resources 1030) or in firmware in an interface circuit in communication resources 1030. Additionally or alternatively, at least some of the operations in the communication techniques can be implemented in a physical layer, such as hardware in an interface circuit in communication resources 1030. In some implementations, the communication techniques are implemented, at least in part, in a MAC layer and/or in a physical layer in an interface circuit in communication resources 1030.

While the preceding implementations illustrated the use of wireless signals in one or more bands of frequencies, in some implementations, electromagnetic signals in one or more different frequency bands are used to determine the range. For example, these signals can be communicated in one or more bands of frequencies, including: a microwave frequency band, a radar frequency band, 900 MHz, 2.4 GHz, 5 GHz, 6 GHz, 60 GHz, and/or a band of frequencies used by a Citizens Broadband Radio Service, by LTE, 5G, or any other communication system.

Although specific components are used to describe electronic device 1000, in some implementations, different components and/or subsystems can be present in electronic device 1000. For example, electronic device 1000 can include one or more additional processing subsystems, memory subsystems, networking subsystems, and/or display subsystems. Additionally, one or more of the subsystems might not be present in electronic device 1000. In some implementations, electronic device 1000 can include one or more additional subsystems that are not shown in FIG. 10. In some implementations, electronic device can include an analysis subsystem that performs at least some of the operations in the communication techniques. Although separate subsystems are shown in FIG. 10, in some implementations some or all of a given subsystem or component can be integrated into one or more of the other subsystems or component(s) in electronic device 1000.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
attaching a user device to a wireless network via a router of a first communications protocol;
determining, based on information about a second session using a second communications protocol, a first time window and a second time window;
determining to perform a first session using the first communications protocol in the first time window;
performing a first arbitration between the first session and the second session;
determining, based on the first arbitration, that the first session has a priority over the second session in the second time window;
performing a second arbitration between the first session and a third session using a third communications protocol; and
determining, based on the second arbitration, whether to perform the first session in the second time window.

2. The method of claim 1, wherein the user device is configured with coordinated sampled listening (CSL), and wherein the method further comprises controlling a CSL timer according to the time window and the second time window.

3. The method of claim 1, wherein the user device is not configured with coordinated sampled listening (CSL), and wherein determining the first time window and the second time window comprises:
obtaining the information about the second session from a wireless manager; and
determining the first time window and the second time window using firmware of the first communications protocol.

4. The method of claim 1, wherein determining to perform the first session in the first time window comprises at least one of:
determining that the user device is configured with coordinated sampled listening (CSL),
determining that the third session operates on a first frequency band, or
determining that the first session has a higher priority than the second session in the first time window.

5. The method of claim 1, wherein determining whether to perform the first session in the second time window comprises:
determining a criticality level of the third session; and
in response to determining that the third session is critical, determining not to perform the first session in the second time window.

6. The method of claim 5, wherein determining whether to perform the first session in the second time window further comprises:
in response to determining that the third session is not critical, determining a criticality level of the first session; and
performing at least one of:
in response to determining that the third session is not critical and the first session is not critical, determining not to perform the first session in the second time window; and
in response to determining that the third session is not critical and the first session is critical, determining to perform the first session in the second time window.

7. The method of claim 6, wherein determining the criticality level of the first session comprises determining an identifier of the first session.

8. The method of claim 1, further comprising:
sending, from firmware of the first session to firmware of the third session, a request to perform the first session in the second time window.

9. The method of claim 1, further comprising:
sending, from firmware of the third session to an access point of the third session, an indication of power reduction to occur in the first time window.

10. The method of claim 1, further comprising:
before the attaching, performing a third arbitration between a fourth session using the first communications protocol and a fifth session using the second communications protocol;
in response to determining that the fourth session has a priority over the fifth session, performing the fourth session; and
in response to determining that the fifth session has a priority over the fourth session, performing the fifth session.

11. The method of claim 1, wherein the router supports the first communications protocol and the third communications protocol.

12. The method of claim 1, wherein the router is coupled to a synchronized sleepy end device.

13. The method of claim 1, wherein the user device is attached to the wireless network indirectly via the router.

14. The method of claim 1, wherein the wireless network comprises one or more sleepy end devices that support the first communications protocol.

15. The method of claim 1, wherein the first communications protocol comprises an Institute of Electrical and Electronics Engineers (IEEE) 802.15.4 standard.

16. The method of claim 1, wherein the second communications protocol comprises a BLUETOOTH standard.

17. The method of claim 1, wherein the third communications protocol comprises a WI-FI standard.

18. A method comprising:
establishing a link using a first communications protocol between a user device and a peer device;
determining, based on information about a second session using a second communications protocol, a first time window and a second time window;
determining to perform a first session via the link in the first time window;
performing a first arbitration between the first session and the second session;
determining, based on the first arbitration, that the first session has a priority over the second session in the second time window;
performing a second arbitration between the first session and a third session using the third communications protocol; and
determining, based on the second arbitration, whether to perform the first session in the second time window.

19. The method of claim 18,
wherein determining to perform the first session in the first time window comprises at least one of:
determining that the user device is configured with coordinated sampled listening (CSL),
determining that the third session operates on a first frequency band, or
determining that the first session has a higher priority than the second session in the first time window, and
wherein determining whether to perform the first session in the second time window comprises:
determining a criticality level of the third session; and
in response to determining that the third session is critical, determining not to perform the first session in the second time window.

20. A user device comprising one or more processors configured to execute instructions that cause the user device to perform operations comprising:
attaching the user device to a wireless network via a router of a first communications protocol;
determining, based on information about a second session using a second communications protocol, a first time window and a second time window;
determining to perform a first session using the first communications protocol in the first time window;
performing a first arbitration between the first session and the second session;
determining, based on the first arbitration, that the first session has a priority over the second session in the second time window;
performing a second arbitration between the first session and a third session using a third communications protocol; and
determining, based on the second arbitration, whether to perform the first session in the second time window.
